(19) United States
(12) Patent Application Publication
(10) Pub. No.: US 2017/0080948 A1
(43) Pub. Date: Mar. 23, 2017

(54) VEHICLE MODE ADJUSTING SYSTEM

(71) Applicant: Faraday&Future Inc., Gardena, CA (US)

(72) Inventors: Matt K. LUBBERS, Manhattan Beach, CA (US); Matt John SAMPSON, Redondo Beach, CA (US); Kenneth K. XIE, Manhattan Beach, CA (US)

(73) Assignee: Faraday&Future Inc., Gardena, CA (US)

(21) Appl. No.: 15/264,623

(22) Filed: Sep. 14, 2016

Related U.S. Application Data
(60) Provisional application No. 62/220,590, filed on Sep. 18, 2015.

(51) Int. Cl. B60W 40/09; B60W 50/14; B60W 50/00

(52) U.S. Cl. CPC B60W 40/09; B60W 50/0098; B60W 50/14; B60W 2540/30; B60W 2050/143

(57) ABSTRACT

A system and method for adjusting drive mode of a vehicle are disclosed. According to certain embodiments, the system may include a processor configured to: receive sensor data generated by one or more sensors in communication with the processor; determine motion of the vehicle based on the sensor data; determine, based on the motion of the vehicle, characteristics of the surface or driving behavior of a user of the vehicle; and determine a drive mode of the vehicle based on the determined characteristics of the surface or driving behavior of the user. The system may further include one or more actuators configured to implement the drive mode.

### CROSS REFERENCE TO RELATED APPLICATIONS

This application claims the benefit of priority based from U.S. Provisional Patent Application No. 62/220,590 filed on Sep. 18, 2015, the entire disclosure of which is incorporated by reference.

### TECHNICAL FIELD

The present disclosure relates generally to a system and method for adjusting a drive mode of a vehicle, and more particularly, to a system and method for automatically adjusting the drive mode based on various factors, such as driving conditions, driver behaviors, and driver preferences, etc.

### BACKGROUND

Modern vehicles provide multiple operation or drive modes that suit different driving conditions, such as road conditions, weather conditions, etc. To switch among the multiple drive modes, a vehicle needs to constantly adjust the configurations of various systems and subsystems of the vehicle. The recent trend of developing smart vehicles demands a vehicle to be capable of accurately assessing the driving conditions and automatically adjusting to a proper drive mode in response to the change of driving conditions. For example, the vehicle may activate an anti-lock braking system (ABS) when encountering a road surface of dry concrete, icy asphalt, or loose dirt. The vehicle may need to further optimize the ABS for each surface condition of the road by altering the response time and the frequency of brake pulsations. The same is needed for traction- and stability-control systems, the locking action of the differentials, the shift schedule of the transmission, the throttle response of the engine, etc.

Moreover, as the number of controllable systems increases, a driver is facing an increasing number of choices as to which configuration modes to select for each of the systems or subsystems. Unless the driver is very experienced, the task of selecting a proper drive mode can become complicated and confusing. Therefore, providing an automatic drive mode adjusting system can improve the driving experience.

Further, driver behaviors differ under different driving conditions. During fair weather on a sparsely populated road, a driver may wish to be in a sports car mode, which permits additional control for higher speed driving. However, when driving in heavy traffic, the same driver may wish to be in comfort mode in which many of the functions of the vehicle are set for a rider's comfort, or in eco mode in which the vehicle may change certain settings, such as reducing the number of cylinders used by the engine, to achieve the highest gas mileage and the lowest emissions. In addition, if the automobile is used for driving on a race track, an additional mode “sport plus” is available. Evidently, it is desirable for a vehicle to select the proper drive modes automatically by learning the driver's preferences.

The disclosed vehicle drive mode adjusting system is directed to mitigating or overcoming one or more of the problems set forth above and/or other problems in the prior art.

### SUMMARY

One aspect of the present disclosure is directed to a system for controlling a vehicle operating on a surface. The system may include a processor configured to: receive sensor data generated by one or more sensors in communication with the processor; determine motion of the vehicle based on the sensor data; determine, based on the motion of the vehicle, characteristics of the surface or driving behavior of a user of the vehicle; and determine a drive mode of the vehicle based on the determined characteristics of the surface or driving behavior of the user. The system may further include one or more actuators configured to implement the drive mode.

Another aspect of the present disclosure is directed to a vehicle. The vehicle may include one or more sensors. The vehicle may also include a controller in communication with the one or more sensors. The controller may be configured to: receive sensor data generated by the one or more sensors; determine motion of the vehicle based on the sensor data; determine, based on the motion of the vehicle, characteristics of the surface or driving behavior of a user of the vehicle; and determine a drive mode of the vehicle based on the determined characteristics of the surface or driving behavior of the user. The vehicle may further include one or more actuators configured to implement the drive mode.

Yet another aspect of the present disclosure is directed to a method for controlling a drive mode of a vehicle. The method may include receiving sensor data generated by the one or more sensors. The method may also include determining motion of the vehicle based on the sensor data. The method may also include determining, based on the motion of the vehicle, characteristics of the surface or driving behavior of a user of the vehicle. The method may further include determining a drive mode of the vehicle based on the determined characteristics of the surface or driving behavior of the user.

### BRIEF DESCRIPTION OF THE DRAWINGS

FIG. 1 is a block diagram of a system for adjusting a drive mode of a vehicle, according to an exemplary embodiment;

FIG. 2 is a schematic diagram illustrating certain exemplary implementations of the system shown in FIG. 1;

FIG. 3 is a flowchart of a method for adjusting a drive mode of a vehicle, according to an exemplary embodiment;

FIG. 4 is a schematic diagram illustrating certain exemplary implementations of the method shown in FIG. 4; and

FIG. 5 is a flowchart of a method for adjusting a drive mode of a vehicle based on surface conditions of a road, according to an exemplary embodiment.

### DETAILED DESCRIPTION

This disclosure is generally directed to a system and method for automatically adjusting a drive mode of a vehicle. It is contemplated that the vehicle may be an electric vehicle, a fuel cell vehicle, a hybrid vehicle, or a conventional internal combustion engine vehicle. The vehicle may have any body style, such as a sports car, a coupe, a sedan, a pick-up truck, a station wagon, a sports utility vehicle (SUV), a minivan, or a conversion van. The vehicle may be configured to be operated by an operator occupying the vehicle, remotely controlled, and/or autonomous.

The disclosed drive mode adjusting system may include a plurality of sensors configured to generate sensor data indicative of driving conditions of the vehicle and/or driving behavior of a driver of the vehicle. The term “diving conditions,” as used in the present disclosure, may refer to conditions of the environment surrounding the vehicle and/or operation status of the vehicle. Conditions of the environment include but are not limited to conditions of the road surface (hereinafter referred to as “surface conditions”), traffic conditions, weather conditions (e.g., temperature and humidity outside the vehicle), etc. Operation status of the vehicle includes but is not limited to the State of Charge (SoC) of the battery, fuel level, wheel speed, motor speed, engine pressure, braking frequency, tire pressure, steering angle, etc. Driving behavior may refer to a driver's way of operating the vehicle, such as whether the driver is driving aggressively or defensively.

The disclosed drive mode adjusting system may be configured to aggregate the sensor data and automatically operate the vehicle in a drive mode suitable for the sensed driving conditions and/or driving behavior. Moreover, the vehicle may continuously learn the driver's driving preferences under similar driving conditions and select the drive mode based additionally on the driving preferences.

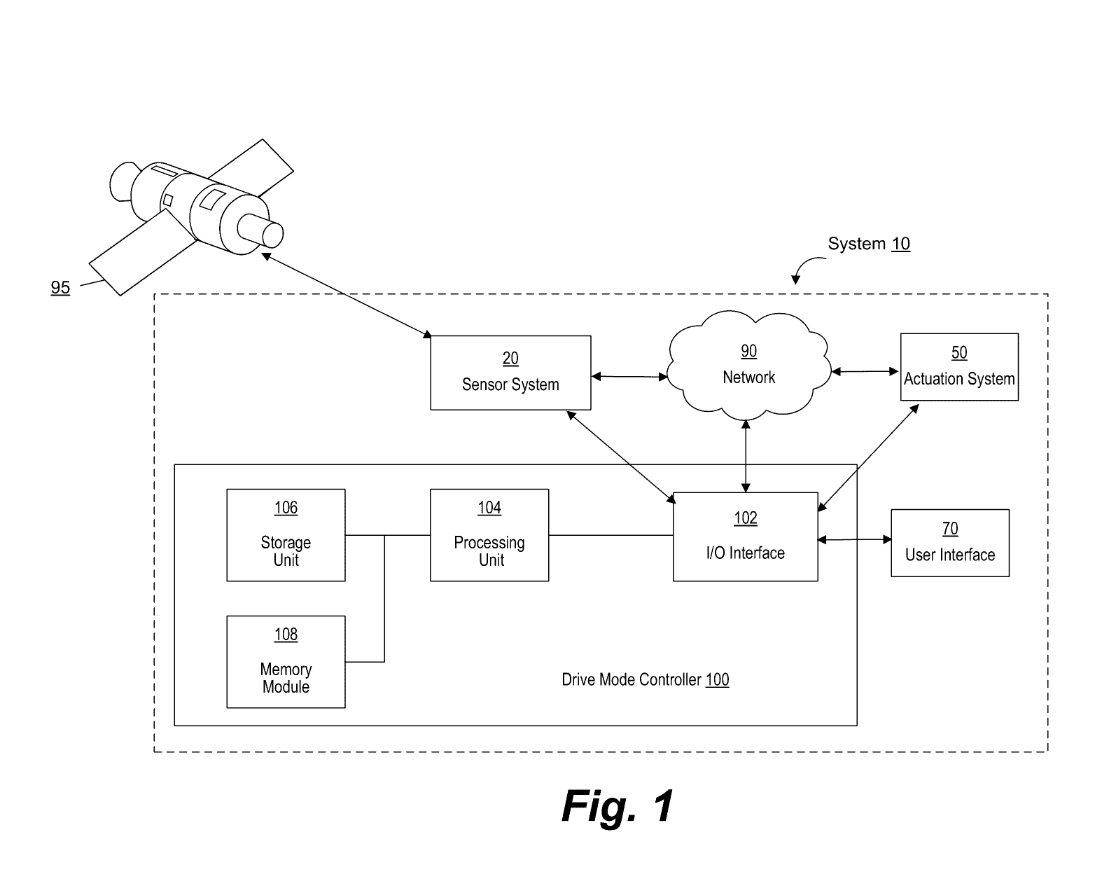

FIG. 1 is a block diagram of a system 10 for adjusting the drive mode of a vehicle, according to an exemplary embodiment. In particular, as described below, system 10 may be configured to automatically adjust the drive mode without user supervision. Referring to FIG. 1, system 10 may include one or more of a drive mode controller 100, a sensor system 20, an actuation system 50, a user interface 70, and a network 90.

Drive mode controller 100 may be used to monitor the driving conditions of the vehicle and/or driving behavior of the driver, and adjust the drive mode of the vehicle in response to changes in the driving conditions and/or driving behavior. With continued reference to FIG. 1, drive mode controller 100 may include, among other things, an input/output (I/O) interface 102, a processing unit 104, a storage unit 106, and a memory module 108. At least some of these components of drive mode controller 100 may be configured to transfer data and send or receive instructions between or among each other.

I/O interface 102 may be configured to facilitate the communication between drive mode controller 100 and other components of system 10. For example, I/O interface 102 may receive sensor data generated by sensor system 20 and transmit the sensor data to processing unit 104 for further processing. I/O interface 102 may also output commands to actuation system 50, to control the operation of various actuators in actuation system 50.

In some embodiments, I/O interface 102 may be configured to communicate with sensor system 20, actuation system 50, and user interface 70 via network 90. Network 90 may be any type of wired or wireless network that may allow transmitting and receiving data. For example, network 90 may be a wired network, a local wireless network (e.g., Bluetooth™ WiFi, near field communications (NFC), etc.), a cellular network, an Internet, or the like, or a combination thereof. Other known communication methods which provide a medium for transmitting data are also contemplated.

Processing unit 104 may include any appropriate type of general-purpose or special-purpose microprocessor, digital signal processor, or microcontroller. Processing unit 104 may be configured as a separate processor module dedicated to adjusting the drive mode of the vehicle in response based on the sensed driving conditions and/or driving behavior. Alternatively, processing unit 104 may be configured as a shared processor module for performing other functions unrelated to adjusting the drive mode of the vehicle.

Processing unit 104 may be configured to receive data and/or signals, via, for example, I/O interface 102, from components of system 10 and process the data and/or signals to determine one or more conditions of the vehicle. For example, processing unit 104 may receive sensor data indicating motion of the vehicle and determine surface conditions based on the motion of the vehicle. Processing unit 104 may also receive information relating to the SoC of the battery. Processing unit 104 may further generate and transmit a control signal for actuating one or more components of actuation system 50.

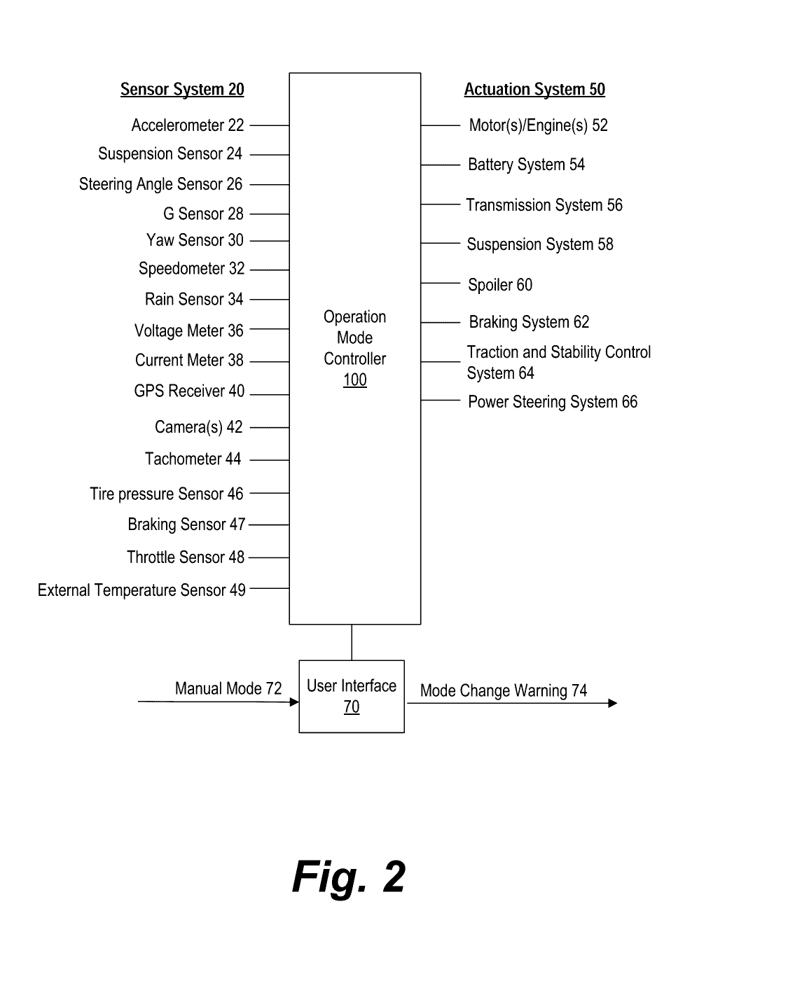

Processing unit 104 may execute computer instructions (program codes) stored in storage unit 106 and memory module 108, and may perform functions in accordance with exemplary techniques described in this disclosure. More exemplary functions of processing unit 104 will be described later in relation to FIGS. 2-5.

Storage unit 106 and memory module 108 may include any appropriate type of mass storage provided to store any type of information that processing unit 104 may need to operate. Storage unit 106 and memory module 108 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Storage unit 106 and/or memory module 108 may be configured to store one or more computer programs that may be executed by processing unit 104 to perform exemplary functions for adjusting the drive mode of the vehicle, as disclosed in this application. For example, storage unit 106 and/or memory module 108 may be configured to store program(s) that may be executed by processing unit 104 to determine the driving conditions of the vehicle and/or driving behavior of the driver based on the sensor data, and create or select a drive mode suitable for the determined driving conditions and/or driving behavior.

Storage unit 106 and/or memory module 108 may be further configured to store information and data used by processing unit 104. For instance, storage unit 106 and/or memory module 108 may be configured to store pre-established criteria (e.g., lookup tables) for various driving modes. When the sensor data, determined driving conditions, and/or determined driving behavior match the criteria for certain drive mode, processing unit 104 may determine the matched mode as the drive mode suitable for current conditions.

FIG. 2 is a schematic diagram illustrating certain exemplary implementations of the system 10. Referring to FIG. 2, sensor system 20 may include a plurality of sensors for detecting driving conditions of the vehicle and/or driving behavior. For example, sensor system 20 may include but are not limited to: an accelerometer 22 configured to determine the acceleration of the vehicle; a suspension sensor 24 configured to determine the stiffness of the suspension; a steering angle sensor 26 configured to determine the angle of the steering wheel as measured from a neutral position indicating that the front wheels of the vehicle are parallel and pointing straight forward; a G or gravitational sensor 28 configured to determine the direction of gravity relative to the plane of the vehicle chassis; a yaw sensor 30 configured to determine the orientation of the chassis with respect to the direction of travel; a speedometer 32 configured to determine the present speed of the vehicle; a rain sensor 34 configured to determine whether the vehicle is operating in the rain or an environment with high humidity; a voltage meter 36 for measuring the battery voltage; a current meter 38 configured to measure the current flow to or from the battery; a GPS receiver 40 to receive road information from a satellite system 95; one or more cameras 42 used for external and internal surveillance; a tachometer 44 configured to measure the engine speed and/or motor speed; one or more tire pressure sensors 46 for measuring the tire pressures; a braking sensor 47 configured to detect the position and/or moving speed of the brake pedal; a throttle sensor 48 configured to monitor the throttle position; and/or an external temperature sensor 49 configured to measure the air temperature outside the vehicle.

Based on the sensor data generated by sensor system 20, system 10 is capable of controlling various actuators in actuation system 50 to effect the desired vehicle performance corresponding various drive modes. In the disclosed embodiments, actuation system 50 include but is not limited to: motor(s) or engine(s) 52; battery system 54; transmission system 56, suspension system 58; spoiler 60; braking system 62, traction and stability control system 64, and/or power steering system 66.

Drive mode controller 100 may tune the settings of actuation system 50, in order to operate the vehicle in a desired drive mode. For example, transmission system 56 may be controlled in sport, winter, economy and manual configuration modes in which the changes between gear ratios and other subsystem control parameters are modified so as to suit the prevailing conditions or the preferences of the driver, wherein the locking or partial locking of differentials can he controlled to suit the prevailing driving conditions. Transmission system 56 may also be switched to provide drive to different numbers of wheels. For another example, the stiffness and height of suspension system 58 may be adjusted to meet the different requirements of on-road and off-road modes. For another example, the positions of spoiler 60 may be adjusted to fit the requirements of different drive modes, such as sport mode. For another example, traction and stability control system 64 may be operated to provide different levels of stability/safety control, such as operated at reduced level of control so as to give the driver more direct control over the operation of the vehicle. For yet another example, power steering system 66 may be operated in different configurations where the level of assistance is at different levels or varies in different ways.

With continued reference to FIG. 2, drive mode controller 100 (i.e., I/O interface 102) may provide a plurality of input ports to receive respective input signals from the sensors in sensor system 20. Drive mode controller 100 may also provide a plurality of output ports for outputting respective control signals to the actuators in actuation system 50. In addition, drive mode controller 100 may be communicatively coupled with user interface 70, via I/O interface 102. In some embodiments, system 10 may provide a manual mode 72 on user interface 70, in which a user may manually select a drive mode, to override the automatic decisions of drive mode controller 100. For example, user interface 70 may include a knob, a dial, a keyboard, and/or a touch screen for the user to manually select the drive mode. In some embodiments, system 10 may be configured to inform a user about the suitable drive mode determined by drive mode controller 100. In particular, system 10 may provide a mode change warning 74 to the user, to allow the user enough warning time to override the mode change. For example, user interface 70 may include a display or a speaker to present visual and/or audio cues indicating an imminent change of drive mode.

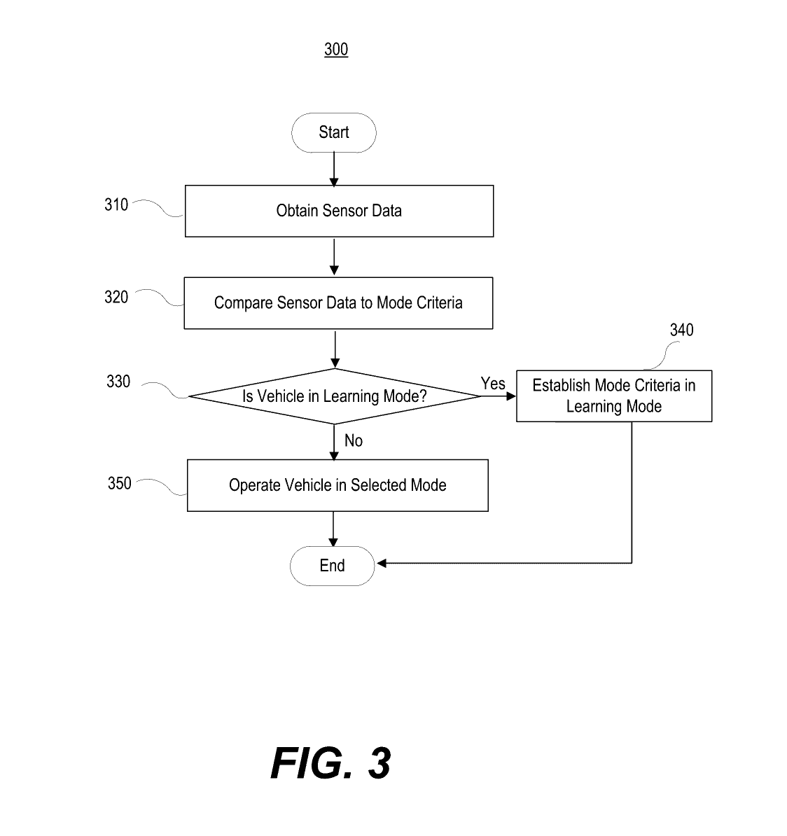

FIG. 3 is a flowchart of a method 300 performed by system 10 to adjust a drive mode of a vehicle, according to an exemplary embodiment. Referring to FIG. 3, method 300 may start with drive mode controller 100 receiving sensor data from sensor system 20 (step 310). As shown in FIG. 2, sensor system 20 may include various types of sensors for measuring various parameters of the vehicle, to provide sensor data to drive mode controller 100. Drive mode controller 100 subsequently may compare the received sensor data to pre-established criteria for various drive modes, to select a drive mode suitable for the sensed conditions (step 320). As described in more details below, when determining that the vehicle currently is not in the selected drive mode, drive mode controller 100 may make adjustments to various vehicle parameters that permit the vehicle to move into the selected drive mode.

Next, in step 330, drive mode controller 100 may determine whether system 10 is working in a learning mode. In the learning mode, the driver is allowed to instruct drive mode controller 100 to note how he or she manually sets the parameters in a given drive mode (e.g. turning off the automatic breaking system, adjusting the spoiler) when he or she enters a region of road. Drive mode controller 100 may then monitor the route, the traffic, and the road conditions, and also associate this data with the drive mode. This way, when the same traffic conditions occur in the future, drive mode controller 100 can automatically adjust the vehicle parameters for the drive mode. As such, if system 10 is working in the learning mode, drive mode controller 100 may establish the mode criteria according to the driver input (step 340). In contrast, if system 10 is not in the learning mode, drive mode controller 100 may proceed to step 350 and operate actuation system 50 in predetermined parameters that correspond to the selected drive mode.

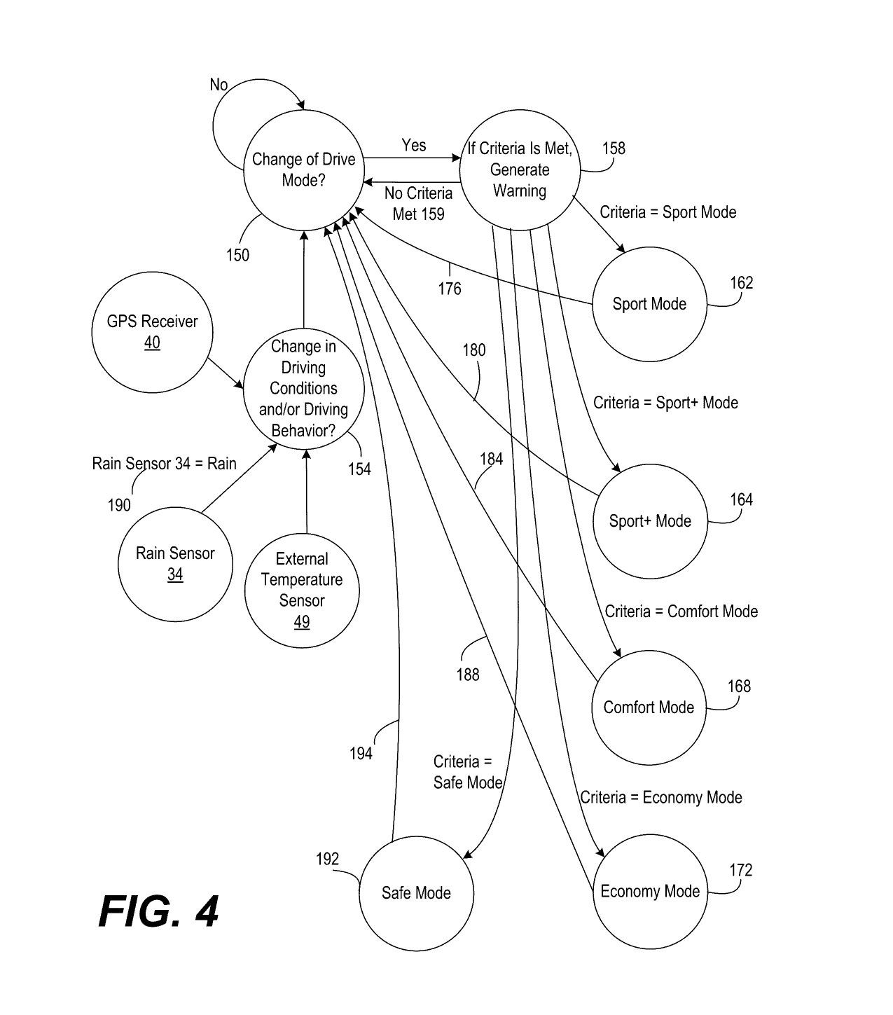

FIG. 4 is a schematic diagram illustrating certain exemplary implementations of method 300. Referring to FIG. 4, system 10 may be preprogrammed to include multiple drive modes, such as Sport Mode 162, Sport+Mode 164, Comfort Mode 168, and Economy (Eco) Mode 172.

In operation, drive mode controller 100 knows the present drive mode 150 and constantly scans for a parameter change 154 that might necessitate a change in mode. If no mode change criteria are met 159, drive mode controller 100 continues to scan for a change of driving conditions and/or driving behavior 154.

For example, using GPS receiver 40, drive mode controller 100 may monitor the current location of the vehicle and road conditions including, e.g., speed limit and current traffic. If GPS receiver 40 detects that a region of road with curves, twists and light traffic is being approached, drive mode controller 100 may determine if this change of road conditions 154 corresponds to a preprogrammed drive mode. Alternatively, a drive mode learned by the system for the driver 158 can be selected based on the detected conditions.

In this example, drive mode controller 100 may determine that the driver prefers to drive in Sport Mode 162 under these conditions. Drive mode controller 100 may issue a warning 158 that a mode change to Sport Mode 162 is about to take place. If the driver does not intervene, system 10 may switch into Sport Mode 162, which includes hardening the suspension, increasing response to throttle changes, adjusting the spoiler position and providing stiffer and heavier steering. Once system 10 is in Sport Mode 162, system 10 returns 176 to scanning parameters for another change in drive mode.

In another example, the drive mode can be set based on the driver's driving behavior. Drive mode controller 100 may determine that the driver is driving aggressively/defensively based, for example, on data received from one or more of the sensors including, but not limited to, accelerometer 22, suspension sensor 24, steering angle sensor 26, G sensor 28, speedometer 32, braking sensor 47, and/or throttle sensor 48. For example, when drive mode controller 100 determines from the sensor data that the driver is constantly adjusting the throttle (based on data from throttle sensor 48), accelerating/braking hard (based on data from braking sensor 47 and/or throttle sensor 48), cornering at high speed (based on data from accelerometer 22, steering angle sensor 26, G sensor 28, and/or speedometer 32), and/or driving at a high speed (based on data from speedometer 32), drive mode controller 100 may switch the vehicle to Sport Mode 162 or Sport+Mode 164. When switching to Sport Mode 162 or Sport+Mode 164, drive mode controller 100 may operate actuation system 50 to, for example, tighten the steering wheel, lower the suspension, extend the rear spoiler, make throttle and braking response more immediate, turning off traction and/or stability controls, etc.

In another example, when the vehicle is electrically driven and a battery sensor, e.g., voltage meter 36 and/or current meter 38, detects that the vehicle is running low on battery, drive mode controller 100 may determine that the proper drive mode should be Eco Mode 172, in which the vehicle minimizes its power output, and automatically switches the car into Eco mode. This switching can involve, for example, limiting the top speed of the vehicle, turning off certain power-consuming modules such as air conditioning.

In yet another example, if rain sensor 34 determines that it is raining 190, drive mode controller 100 may announce, via user interface 70, to the driver a change in mode 158. Unless the driver intervenes, drive mode controller 100 may operate actuation system 50 to switch the vehicle to Comfort Mode 168, which adjusts the settings, e.g., softens the suspension, turns on traction control and top speed limiter, and reduces motor or engine reaction to throttle changes.

Similarly, when an external temperature sensor 49 detects a temperature below freezing and drive mode controller 100 receives weather information that it has recently rained where the vehicle is traveling, drive mode controller 100 may set the vehicle in Safe Mode 192 with all safety systems (e.g., traction and stability control system 64) turned on and/or limit the top speed of the vehicle. As another example, when external temperature sensor 49 detects a temperature above a certain threshold over which the vehicle is likely to overheat if being driven aggressively, drive mode controller 100 may switch the vehicle from Sport Mode 162 or Sport+Mode 164 to Comfort Mode 168, in which the vehicle is less likely to overheat.

The various exemplary settings for the different modes are recited in the following Table 1.

TABLE 1

| | | Traction | | |
|---|---|---|---|---|
| Mode | Suspension | control | Throttle control | Steering |
| Comfort Mode | Softer | On | Less responsive | More reactive |
| 168 | | | | |
| Eco Mode 172 | Softer | On | Less responsive | More reactive |
| Sport Mode 162 | Stiffer | On | Intermediate | Stiffer, less |
| | | | | reactive |
| Sport + Mode | Stiffer | Off | More responsive | Stiffest, least |
| 164 | | | | reactive |

One of the advantages of the current disclosure is that automatically setting the vehicle in the drive mode most suitable for the driving conditions and/or the driver's driving behavior or style (e.g., switching the drive mode to Comfort Mode or Safe Mode in the rain) can improve driving safety.

It is important to note that the discloses system, in addition to warning the driver about an impending mode change, will not permit mode changes if the change of mode would place the driver at risk. For example, if the vehicle is traveling at high speed, a mode change that requires a lower speed will not occur until the vehicle's speed is reduced.

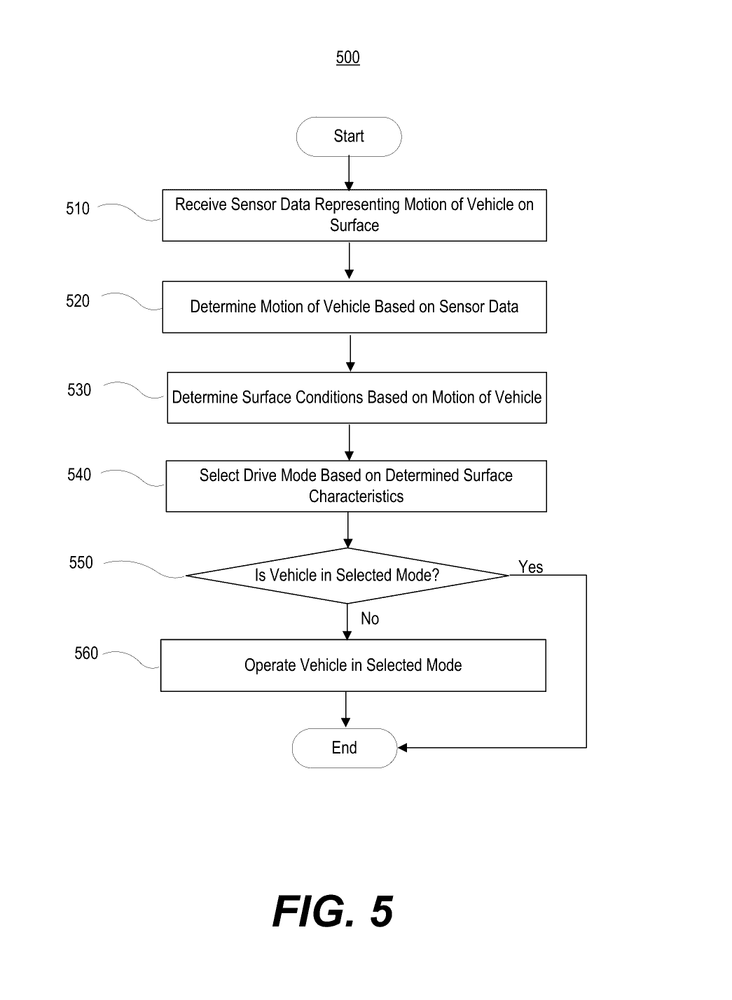

Next, in connection with FIG. 5, a specific example of adjusting the drive mode of a vehicle based on surface condition of the road will be described. FIG. 5 is a flowchart of a method 500 for adjusting the drive mode based on surface conditions of a road. Referring to FIG. 5, method 500 may be performed by system 10 and include steps 510-560.

In step 510, drive mode controller 100 may receive, from sensor system 20, sensor data representing the real-time motion of the vehicle. For example, sensor system 20 may include any number and/or combination of sensors known in the art for generating signals indicative of the motion of the vehicle, i.e., position, orientation, acceleration, velocity, heading, angular rate, and/or other motion parameters of vehicle. For example, accelerometer 22 may be used to detect the linear acceleration of the vehicle in a direction parallel to the chassis, while suspension sensor 24 may be used to detect the linear acceleration of the vehicle in a vertical direction. Moreover, yaw sensor 30 may be used to detect the yaw rate of the vehicle. In certain embodiments, various devices measuring the angular rates and acceleration of the vehicle may be integrated in an inertial measurement unit (IMU). For example, the IMU may be a 6-degree of freedom (6 DOF) IMU, which consists of a 3-axis accelerometer, 3-axis angular rate gyros, and sometimes a 2-axis inclinometer. The 3-axis angular rate gyros may provide signals indicative of the pitch rate, yaw rate, and roll rate of the vehicle. The 3-axis accelerometer may provide signals indicative of the acceleration of the vehicle in the x, y, and z directions.

In the disclosed embodiments, the sensor data may also be generated by speedometer 32, GPS receiver 40, a compass, a ground speed radio detection and ranging (RADAR) or a light detection and ranging (LIDAR) receiver, etc. The present disclosure does not limit the types of sensors used to generate the sensor data representing the motion of the vehicle.

After receiving the sensor data, in step 520, drive mode controller 100 may determine the motion of the vehicle based on the sensor data (step 520). For example, drive mode controller 100 may receive sensor data indicative of the angular rates (roll rate, yaw rate, and pitch rate) of the vehicle from sensor system 20. By integrating the angular rates, drive mode controller 100 may determine the attitude or angular orientation (roll, heading, and pitch) of the vehicle.

In step 530, drive mode controller 100 may determine the surface conditions based on the sensor data. For example, by analyzing the vibration magnitude and frequency of the vehicle, drive mode controller 100 may determine whether the vehicle is entering a region with rough surface. For another example, by comparing the wheel speed of the vehicle and the velocity of the vehicle, drive mode controller 100 may determine whether a wheel slip is present. Based on the amount of the wheel slip, drive mode controller 100 may further determine the severity of the surface slipperiness. Moreover, combining the information provided by, for example, rain sensor 34, drive mode controller 100 may further determine whether the slipperiness is due to rain, ice, or dry concrete.

In step 540, drive mode controller 100 may select a suitable drive mode based on the determined surface conditions. For example, when determining that the road surface is icy, drive mode controller 100 may determine that Safe Mode 190 is the suitable mode, in which actuation system 50, such as braking system 62, traction and stability control system 64, and/or power steering wheel 66, may be adjusted to improve the maneuverability and stability of the vehicle. For example, braking system 62 may employ the ABS to closely modulate the braking force, and power steering system 66 may prevent unintended change of steering angle.

In some embodiments, instead of selecting the suitable drive mode from the preprogramed drive modes, drive mode controller 100 may also be configured to create a new drive mode suitable for the real-time driving conditions and driving behavior. For example, when the road surface is bumpy, drive mode controller 100 may fine-tune the stiffness and/or height of suspension system 58 and continuously solicit a user's feedback about the comfortableness of the vehicle. When the user indicates, via user interface 70, that he or she feels comfortable with certain state of the vehicle, drive mode controller 100 may fix the settings of suspension system 58. Moreover, drive mode controller 100 may save the settings of suspension system 58 as part of the operation parameters for a new Comfort Mode, such that when the vehicle encounters similar pattern of bumpiness in the future, drive mode controller 100 may directly operate the vehicle in the new Comfort Mode.

In step 550, drive mode controller 100 may determine whether the vehicle is presently in the selected drive mode. If the vehicle has already been in the selected drive, method 500 may end. However, if the vehicle is not in the selected drive mode, drive mode controller 100 may operate actuation system 50 to automatically switch the vehicle to the selected drive mode (step 560).

As described before, system 10 may be configured to permit a user to manually override the automatic adjustment of the drive mode. For example, before switching to the selected drive mode, drive mode controller 100 may generate, via user interface 70, a mode change warning 74. If drive mode controller 100 does not receive any user input within a predetermined amount of time, drive mode controller 100 may proceed to make the automatic mode adjustment. However, if within the predetermined amount of time, drive mode controller 100 receives a user selection of a different drive mode, drive mode controller 100 may instead switch the vehicle to the mode chosen by the user.

In some embodiments, system 10 may incorporate additional safety features to prevent a user from implementing a drive mode that is dangerous to the detected surface conditions. For example, if drive mode controller 100 determines that the road surface is extremely slippery while receives a manual input from the user to select Sport+Mode 164, drive mode controller 100 may reject the user selection and inform the user, via user interface 70, that his or her intended mode switching is dangerous and cannot be implemented at this moment.

In some embodiments, drive mode controller 100 may further determine whether any hazardous condition is present on the road surface and generate an alert to the driver when the hazardous condition is present. For example, when drive mode controller 100 determines that the slipperiness of the road has reached a level causing safety hazard, drive mode controller 100 may alert the driver to take extra caution to operate the vehicle or temporarily stop the vehicle. In some embodiments, drive mode controller 100 may also provide driving suggestions to the driver as to how to tackle the hazard. For example, when determining the road underneath the vehicle has deformable surface like gravel, drive mode controller 100 may alert the driver to closely control the steering wheel in order to maintain the driving direction and/or provide necessary force to slow down the vehicle. In one embodiment, drive mode controller 100 may activate the autonomous driving function to take control of the vehicle when a hazard on the road surface is detected.

In some embodiments, drive mode controller 100 may also be configured to transmit the determined surface conditions to other vehicles nearby, such as vehicles that have no automatic surface detection capabilities or are driving behind the vehicle hosting drive mode controller 100. Drive mode controller 100 may also inform other vehicles about the changes that the road surface causes to the actuations system, such as wheel slip, suspension height, wheel articulation, and/or other actuator, settings. This way, other vehicles and/or drivers may take necessary measures before entering the respective road regions.

Although method 500 is described as determining surface conditions based on the motion of the vehicle, it is contemplated that the disclosed method can also be altered to determine driving behavior of a driver or other conditions of the vehicle based on the motion of the vehicle. These alterations are understood to be within the abilities of those skilled in the art and will be repeated here.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed vehicle mode adjusting system and related methods. Other embodiments will be apparent to those skilled in the art from consideration of the specification and practice of the disclosed vehicle mode adjusting system and related methods. It is intended that the specification and examples be considered as exemplary only, with a true scope being indicated by the following claims and their equivalents.

What is claimed is:

1. A system for controlling a vehicle operating on a surface, the system comprising:
a processor configured to:
receive sensor data generated by one or more sensors in communication with the processor;
determine motion of the vehicle based on the sensor data;
determine, based on the motion of the vehicle, characteristics of the surface or driving behavior of a user of the vehicle; and
determine a drive mode of the vehicle based on the determined characteristics of the surface or driving behavior of the user; and
one or more actuators configured to implement the drive mode.

2. The system of claim 1, wherein the processor is further configured to:
determine the drive mode based additionally on information regarding preferences of a user.

3. The system of claim 2, wherein the information regarding the preferences of the user indicates a drive mode determined by the user during a previous occurrence of the determined characteristics of the surface or driving behavior of the user.

4. The system of claim 1,
wherein the drive mode is a first mode; and
wherein the processor is further configured to:
receive a user input of a second drive mode;
determine whether the second drive mode is safe for the determined characteristics of the surface;
when it is determined that the second drive mode is safe, operate the vehicle in the second drive mode; and
when it is determined that the second drive mode is not safe, operate the vehicle in the first drive mode.

5. The system of claim 1, wherein the processor is further configured to:
determine, based on the sensor data, traffic conditions, weather conditions, or operation status of the vehicle; and
determine the drive mode based additionally on the traffic conditions, weather conditions, or operation status of the vehicle.

6. The system of claim 1, wherein the processor is further configured to:
when determining that the vehicle is not in the drive mode, automatically switch the vehicle to the drive mode.

7. The system of claim 6, wherein the processor is further configured to:
switch the vehicle to the drive mode by activating the one or more actuators of the vehicle.

8. The system of claim 7, wherein the processor is further configured to:
activate the one or more actuators to adjust at least one of motor operation, engine operation, battery operation, transmission gearing, suspension stiffness, spoiler position, brakes, traction control, or steering wheel operation.

9. The system of claim 1, wherein the sensor data is generated by at least one of an accelerometer, a suspension sensor, a steering angle sensor, a gravitational sensor, a yaw sensor, a speedometer, a GPS receiver, or a camera.

10. The system of claim 1, wherein the processor is further configured to:
determine the drive mode based on a comparison of the determined characteristics of the surface to predetermined mode criteria.

11. The system of claim 1, wherein the processor is further configured to:
detect a hazardous condition of the vehicle based on the determined characteristics of the surface.

12. The system of claim 10, wherein the processor is further configured to:
in response to the detection of the hazardous condition, generate an alert to a user of the vehicle.

13. The system of claim 1, wherein the processor is further configured to:
transmit information regarding the determined characteristics of the surface to a second vehicle.

14. A vehicle, comprising:
one or more sensors;
a controller in communication with the one or more sensors, the controller being configured to:
receive sensor data generated by the one or more sensors;
determine motion of the vehicle based on the sensor data;
determine, based on the motion of the vehicle, characteristics of the surface or driving behavior of a user of the vehicle; and
determine a drive mode of the vehicle based on the determined characteristics of the surface or driving behavior of the user; and
one or more actuators configured to implement the drive mode.

15. The vehicle of claim 14, wherein the controller is further configured to:
when determining that the vehicle is not in the drive mode, automatically switch the vehicle to the drive mode.

16. The vehicle of claim 14,
wherein the controller is further configured to switch the vehicle to the drive mode by activating the one or more actuators of the vehicle.

17. The vehicle of claim 14, wherein the sensors include at least one of an accelerometer, a suspension sensor, a steering angle sensor, a gravitational sensor, a yaw sensor, a speedometer, a GPS receiver, or a imaging sensor.

18. The vehicle of claim 14, further comprising:
a user interface configured to receive a user input for manually selecting a drive mode of the vehicle.

19. A method for controlling a drive mode of a vehicle, the method comprising:
receiving sensor data generated by the one or more sensors;
determining motion of the vehicle based on the sensor data;
determining, based on the motion of the vehicle, characteristics of the surface or driving behavior of a user of the vehicle; and
determining a drive mode of the vehicle based on the determined characteristics of the surface or driving behavior of the user.

20. The method of claim 19, further comprising:
when determining that the vehicle is not in the drive mode, automatically switch the vehicle to the drive mode.
